(19) United States
(12) Patent Application Publication
(10) Pub. No.: US 2012/0111130 A1
(43) Pub. Date: May 10, 2012

(54) DILUTION TIP

(76) Inventor: Juha Telimaa, Jarvenpaa (FI)

(21) Appl. No.: 13/255,310

(22) PCT Filed: Mar. 8, 2010
(86) PCT No.: PCT/FI2010/050171

§ 371 Date: Jan. 25, 2012

(30) Foreign Application Priority Data
Mar. 9, 2009 (FI) 20095230

(51) Int. Cl. G01N 1/12

(52) U.S. Cl. 73/864.72

(57) ABSTRACT

A tip comprising, at its lower end, a capillary channel (1), the length of which is greater than the thickness of the wall of the tip lower end and the cross-sectional area of which is so small that when the end of the tip is pushed into the liquid, the capillary channel is filled with liquid, and the tip comprises an air opening (3) above the capillary channel.

### TECHNICAL FIELD

The invention relates to the dosing of liquids and concerns a tip container or tip for a liquid, which container is placed in a suction device and which can be used to dilute a liquid sample.

### BACKGROUND ART

In laboratories, for example, liquid samples can be diluted so that both the sample and a diluent are successively sucked into the tip of a pipette without emptying the tip in between. For this, the secondary kinetic action generally used in pipettes can also be used, the purpose of which action is to provide as complete emptying of the tip as possible.

The specification U.S. Pat. No. 4,596,780 discloses a dilution device that has a closed vacuumized container, the lower end of which comprises a thin tubular tip that is easy to break. The lower end of the tube is provided with a flexible tube that has a hole in its jacket. The lower end of the tube comprises a capillary tube, so that the hole of the tube remains between the container tube and the capillary tube. The device is used so that the sample to be diluted is sucked into the capillary tube by means of capillary attraction. Thereafter, the lower end of the device is pushed into the diluent, so that the hole of the tube comes under the liquid level, after which the tubular tip of the container is broken, whereby the diluent flows into the container under the effect of a vacuum.

### GENERAL DESCRIPTION OF THE INVENTION

According to independent claims, a tip, suction device and dilution method have now been invented. The dependent claims present some preferred embodiments of the invention.

The lower end of the tip according to the invention comprises a capillary channel and the tip above the same comprises an air opening. The length of the capillary channel is greater than the thickness of the wall of the tip lower end and its cross-sectional area is so small, that when the end of the tip is pushed into the liquid to be dosed, the capillary channel is filled with liquid. Due to the air opening, the capillary channel is always filled completely. The cross-sectional area of the tip above the capillary channel is so large that no liquid is drawn into it by capillary attraction.

The upper end of the capillary channel most preferably forms a sharp edge with the wall of the tip, whereby the volume of the column that is drawn into the channel is always the same as accurately as possible.

The dilution can be carried out so that the tip is attached to the end of the suction channel of a suction device, the lower end of the tip is pushed into the sample, so that the air opening is above the sample level, and the capillary channel is allowed to be filled. Thereafter, the tip is pushed into the diluent, so that the air opening comes below the liquid level, and the diluent is sucked into the tip. The suction device may be a conventional pipette that is used in laboratories.

The cross-sectional area of the air opening is preferably smaller than the smallest cross-sectional area of the capillary channel. The smaller the air opening, the larger part of diluent comes to the tip through the capillary channel and, correspondingly, the larger part of the mixture exits through the capillary channel. The air opening may also consist of several smaller holes.

The air opening is preferably directed downwards, most preferably directly downwards, whereby the liquid exits downwards through the opening. For the air opening to be directly downwards, the tip must have an upwards widening part, where the air opening is situated. The tip most preferably has, immediately above the capillary channel, a widening part that comprises the air opening. Above this, there is a part that widens more gently.

The air opening is most preferably as close to the lower end of the tip as possible for it to always remain under the level, when a large amount of liquid is sucked into the tip or when the liquid is sucked from a low column. In that case, also the amount of liquid that possibly remains in the tip when emptying is as small as possible.

The volume of the tip is so great that the amount of diluent needed can be sucked into it without the liquid level in the tip reaching the suction device.

The tip is most preferably made of a suitable plastic material by injection moulding.

According to the invention, an accurate and repeatable dilution ratio is provided even on great dilutions. The dilution ratio can be selected by changing the suction volume of the suction device. Typically, the dilution ratio is, e.g., 1:10-1:20, but it can also be, e.g., about 1:100 where necessary.

The capillary tip can also be used for dosing small standard volumes. In that case, liquid is drawn up the capillary channel only and it is emptied by blowing by a piston. The capillary channel is emptied, when all of the air to be displaced has no time to exit through the air opening.

The invention also relates to a suction device and to a dilution method.

### DRAWINGS

The appended drawings are part of the written description of the invention and they relate to the detailed description of some embodiments of the invention presented in the following.

FIG. 1 shows a tip according to the invention,

FIG. 2 shows a section of FIG. 1 and

FIG. 3 shows a partial enlargement of FIG. 2.

### DETAILED DESCRIPTION OF SOME EMBODIMENTS OF THE INVENTION

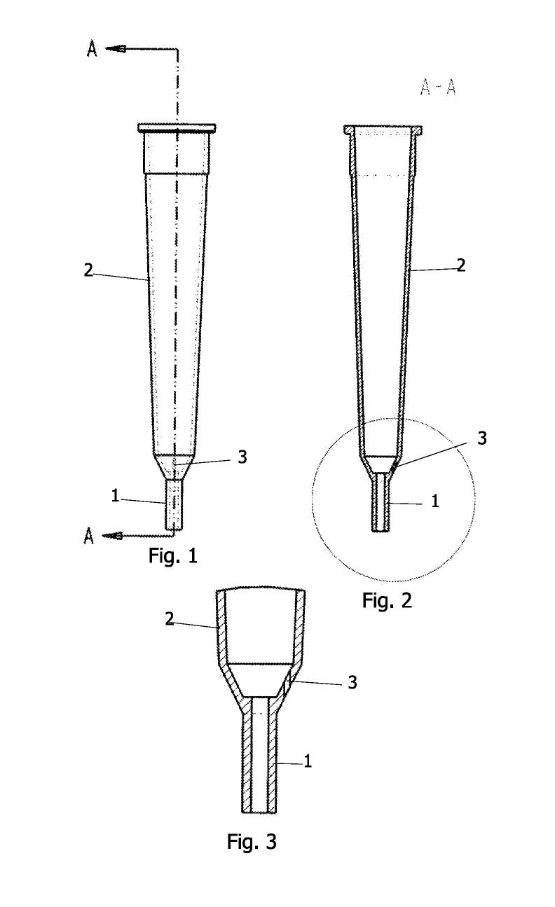

The tip according to FIGS. 1-3 comprises, at its lower end, a capillary channel 1 that is thinner than the rest of the tip. The cross-sectional area of the channel is sufficiently small, so that when the tip of the channel is pushed into the liquid to be diluted, the channel is filled by capillary attraction. The cross-sectional area of the container part 2 above the capillary channel, on the other hand, is so large that no liquid is drawn into it by capillary attraction. The container part comprises an air hole 3 on the wall of the tip. The cross-sectional area of the air hole is smaller than that of the capillary channel.

The upper end of the capillary channel forms a sharp edge with the wall of the tip. At first, the tip widens at right-angles from the upper edge of the capillary channel, then at a relatively large coning angle, whereby a widening extension is formed. The air hole 3 is situated in this extension. Above the extension, the tip widens at a relatively small coning angle.

The tip is attached to a suction device, such as a piston pipette. The end of the tip is pushed into the liquid to be diluted, whereby the capillary channel 1 is filled with liquid. At this stage, the air hole 3 should be above the liquid level. When using a conventional piston pipette, in practice, the piston must then be kept in its lower position. Then the tip is moved to the diluent and pushed so deep that the air hole is below the level, and a desired amount of diluent is sucked into the tip. Part of the diluent flows to the tip through the capillary channel. The liquid sample thus moves to the upper part of the tip along with the diluent. The liquid mixture can now be removed by emptying the tip.

1.-5. (canceled)

6. A tip comprising
a tubular jacket that has an upper end, at which the tip is attached to the end of the suction channel of a suction device, and a lower end, through which liquid is sucked into the tip, the tip being of one piece,
at the lower end of the tip, a capillary channel, the length of which is greater than the thickness of the wall of the tip lower end and the cross-sectional area of which is so small that when the end of the tip is pushed into the liquid, the capillary channel is filled with liquid, and
an air opening above the capillary channel.

7. A tip according to claim 6, wherein the tip widens at the upper edge of the capillary channel, so that a sharp edge is formed at the upper end of the capillary channel.

8. A tip according to claim 6, wherein the cross-sectional area of the air opening is smaller than the smallest cross-sectional area of the capillary channel.

9. A suction device comprising
a suction channel, which has a piston and
a tip that is attached to the end of the suction channel and is of one piece, the tip comprising
a tubular jacket that has an upper end at which the tip is attached to the end of the suction channel, and a lower end, through which liquid is sucked into the tip,
at the lower end of the tip, a capillary channel, the length of which is greater than the thickness of the wall of the tip lower end and the cross-sectional area of which is so small that when the end of the tip is pushed into the liquid, the capillary channel is filled with liquid, and
an air opening above the capillary channel.

10. A method of diluting a liquid sample, wherein
a tip that is of one piece is attached to the end of the suction channel of a suction device provided with a piston, the tip comprising, at its lower end, a capillary channel, the length of which is greater than the thickness of the wall of the tip lower end and the cross-sectional area of which is so small that when the end of the tip is pushed into the liquid, the capillary channel is filled with liquid, and the tip further comprising an air opening above the capillary channel;
the lower end of the tip is pushed into the sample, so that the air opening is above the liquid, and the sample is allowed to fill the capillary channel;
the tip is pushed into the diluent, so that the air opening comes below the liquid level; and
the diluent is sucked into the tip.
